(19) United States
(12) Patent Application Publication
(10) Pub. No.: US 2010/0332100 A1
(43) Pub. Date: Dec. 30, 2010

(54) LAND VEHICLE CRUISE CONTROL

(76) Inventor: Ronald David Faggetter, Toronto (CA)

Correspondence Address: Ron Faggetter, 17 Dacre Cr., Toronto, ON, M6S 2W2, CA

(21) Appl. No.: 12/536,045

(22) Filed: Aug. 5, 2009

Related U.S. Application Data
(60) Provisional application No. 61/086,535, filed on Aug. 6, 2008.

(51) Int. Cl. G06F 19/00

(52) U.S. Cl. 701/93

(57) ABSTRACT

To control the torque of a rotary engine of a land vehicle, an upper speed limit and a lower speed limit for the vehicle is obtained based on at least one user input. A constant output torque is determined for the rotary engine. This may be based on the upper speed limit. The current speed of the vehicle is obtained. While the current vehicle speed lies between the upper speed limit and the lower speed limit, an engine control signal is generated in order to operate the rotary engine at the constant output torque. If the current vehicle speed increases above the upper speed limit, an engine control signal is generated to operate the rotary engine at a reduced output torque below the constant output torque. If the current vehicle speed decreases below the lower speed limit, an engine control signal is generated to operate said rotary engine at an increased output torque above the constant output torque.

### CROSS-REFERENCE TO RELATED APPLICATION

This application claims priority from U.S. provisional application No. 61/086,535 filed Aug. 6, 2008, the contents of which are incorporated herein by reference.

### BACKGROUND

This invention relates to managing the energy output of a driving engine of a land vehicle.

Cruise controls are a common feature of automobiles. With a typical cruise control, a driver arms the control, accelerates to a desired speed, and then indicates the attained speed as the set speed by, for example, toggling a lever of a user interface. The cruise control thereafter controls the engine throttle valve in order to maintain the vehicle at the set speed, increasing engine output torque, as required, while climbing hills and decreasing engine output torque, while descending hills.

### SUMMARY

Typical cruise controls aggressively increase engine output torque on encountering a hill to minimize deviations from the set speed. While such cruise controls provide advantages, they do not maximize the efficiency of the engine.

To control the torque of a rotary engine of a land vehicle, an upper speed limit and a lower speed limit for the vehicle is obtained based on at least one user input. A constant output torque is determined for the rotary engine. This may be based on the upper speed limit. The current speed of the vehicle is obtained. While the current vehicle speed lies between the upper speed limit and the lower speed limit, an engine control signal is generated in order to operate the rotary engine at the constant output torque. If the current vehicle speed increases above the upper speed limit, an engine control signal is generated to operate the rotary engine at a reduced output torque below the constant output torque. If the current vehicle speed decreases below the lower speed limit, an engine control signal is generated to operate said rotary engine at an increased output torque above the constant output torque.

Other features and advantages of the invention will be apparent from the following description in conjunction with the drawings.

### DRAWINGS

In the figures which illustrate an example embodiment of the invention,

FIG. 1 is a schematic diagram of a vehicle engine control system, and

FIG. 2 is a flow diagram illustrating operation of the controller of FIG. 1.

### DETAILED DESCRIPTION

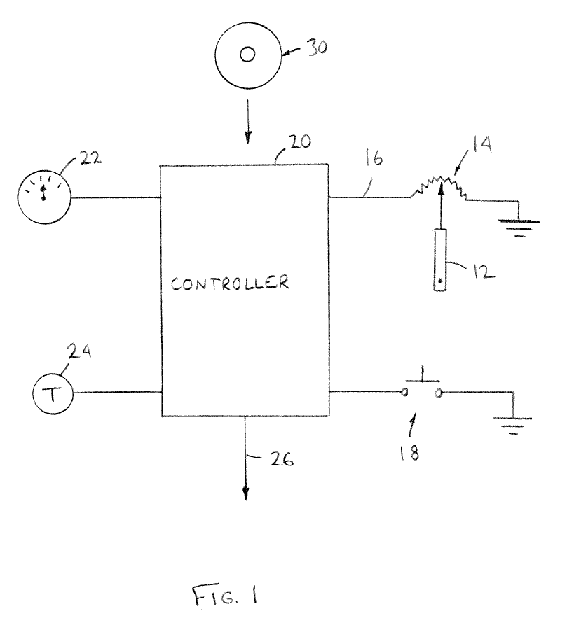

Turning to FIG. 1, which schematically illustrates a drive-by-wire vehicle engine control system 10, adjustment of an accelerator pedal 12 adjusts a potentiometer 14 to vary a voltage signal 16 inputting a controller 20. The controller is also input by a cruise set signal from user interface 18, a speed signal from vehicle speed sensor 22, and a torque signal from engine output torque sensor 24. The controller outputs a control signal 26 to control the engine throttle valve of the engine, and therefore the output torque of the engine.

The controller is loaded with software from a computer readable medium 30.

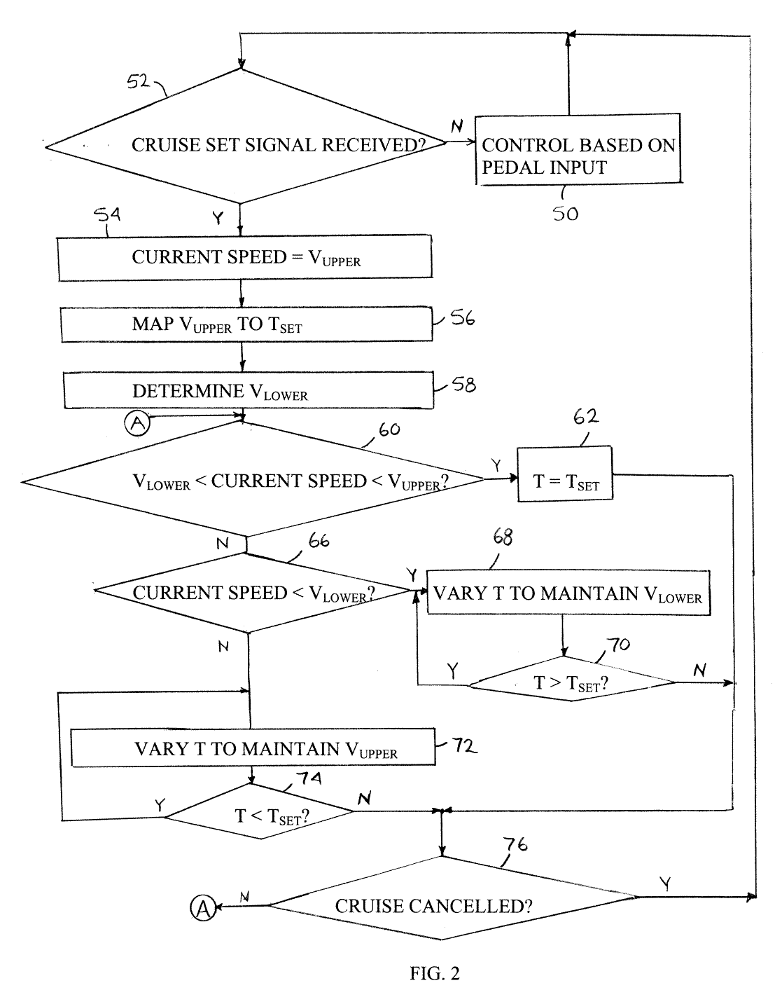

The cruise control function of the controller has two modes: a constant torque mode and a constant speed mode. When first engaged, the cruise control function is in the constant torque mode. FIG. 2 illustrates the operation of the controller. Turning to this figure, a user, by adjusting the position of the pedal 12, may control the engine output torque (50). When the vehicle is traveling at a speed which the driver considers to be a desired speed, the driver may, through user interface 18 (which could be a button or a lever), send a cruise set signal to the controller 20 (52). On receiving this signal, the controller initiates constant torque mode by storing the current speed of the vehicle as an upper speed, Vᵤₚₚₑᵣ (54), and, through a mapping table, mapping this upper speed to an engine output torque, Tₛₑₜ (56), representative of the vehicle traveling at the upper speed on a level road. The controller also selects a lower speed, V_{lower}, as a function of the upper speed (58). This may be, for example, 90% of the upper speed. Thereafter, while the current speed of the vehicle lies between the upper speed and the lower speed, the controller outputs a level control signal so that the engine operates at a constant output torque of Tₛₑₜ (60, 62).

If, however, the current speed of the vehicle drops below the lower speed (66)—indicating that the vehicle is traveling up a substantial hill—the controller switches from constant torque mode to a constant speed mode in which torque is increased until the lower speed is reached (68). In this regard, the rate at which torque is increased can vary directly with the difference between the current speed and the lower speed. When, while in constant speed mode, the torque necessary to maintain the lower speed decreases to the constant torque—indicating that the vehicle is clearing the hill—the controller returns to constant torque mode (70).

If the current speed of the vehicle increases above the upper speed—indicating that the vehicle is traveling down a substantial hill—the controller switches to constant speed mode, decreasing torque until the speed drops back to the upper speed (72). When, while in constant speed mode, the torque increases back to the constant torque—indicating that the vehicle is moving past the down hill section, the controller returns to constant torque mode (74).

As is conventional, at any time, the user may cancel the cruise control through a suitable user input (as, for example, by applying the brake—not shown) (76).

As described, the constant output torque selected by the controller is obtained by mapping the selected upper speed to a torque. The mapping may be based on a factory set table so that each torque in the table is that required to move the vehicle at a certain speed on a level paved road. However, the torques in the table may not be accurate in given driven driving conditions where, for example, there is a significant persistent headwind or a gravel road (which increases drag). To accommodate this, the user interface may allow a user to tune the constant output torque (i.e., adjust it upwardly or downwardly). Alternatively, when the vehicle is on a flat stretch, the user interface may allow the user to enter a training mode prompting the controller to select the output torque currently required to maintain the upper speed as the constant output torque.

The described operation can improve engine efficiency in hilly terrain. Specifically, on an uphill stretch, the torque of the engine (engine throttle setting) is initially unchanged from a set point and the vehicle is allowed to slow from a pre-set upper speed while climbing the hill. The engine torque (throttle setting) is only increased if the speed drops below a specific lower speed. Then, on the ensuing downhill section, where the speed had dropped below the pre-set upper speed, the engine torque will be maintained at the set point until the speed recovers to the pre-set upper speed. Thus, the vehicle operated in this way works with the force of gravity to improve energy efficiency.

In the exemplary embodiment, the lower speed is determined as 90% of the upper speed as it is believed this magnitude of speed reduction would be acceptable to many drivers. However, greater gains in efficiency can be enjoyed if the magnitude of speed reduction were larger. In this regard, in another embodiment, the user interface could be more extensive, allowing a user to select both the upper and lower speeds, rather than having the controller select the lower speed based on the upper speed.

While the subject invention has been described in conjunction with a rotary engine, more generally, it may be applied to any engine which propels a vehicle, such as a linear engine. In such instance, the parameter controlled would more generally be the output energy of the engine.

Other features and modification will be apparent to those skilled in the art and, therefore, the invention is defined in the claims.

What is claimed is:

1. A method of torque control for a rotary engine of a land vehicle, comprising:
based on at least one user input, obtaining an upper speed limit and a lower speed limit for said vehicle;
determining a constant output torque for said rotary engine for said vehicle;
obtaining a current speed of said vehicle;
while said current speed lies between said upper speed limit and said lower speed limit, generating an engine control signal to operate said rotary engine at said constant output torque;
if said current vehicle speed increases above said upper speed limit, generating an engine control signal to operate said rotary engine at a reduced output torque below said constant output torque;
if said current vehicle speed decreases below said lower speed limit, generating an engine control signal to operate said rotary engine at an increased output torque above said constant output torque.

2. The method of claim 1 wherein said determining a constant output torque is based on said upper speed limit.

3. The method of claim 1 wherein said upper speed limit is obtained from a user input.

4. The method of claim 3 wherein said lower speed limit is determined based on said upper speed limit.

5. The method of claim 4 wherein said lower speed limit is determined as about 90% of said upper speed limit.

6. A method of energy management for an engine of a land vehicle, comprising:
based on at least one user input, obtaining an upper speed limit and a lower speed limit for said vehicle;
determining a constant output energy for said engine for said vehicle;
measuring current speed of said vehicle;
while said current speed lies between said upper speed limit and said lower speed limit, operating said engine so as to deliver said constant output energy;
if said current vehicle speed increases above said upper speed limit, reducing output energy of said engine below said constant output energy;
if said current vehicle speed decreases below said lower speed limit, increasing output energy of said engine above said constant output energy.

7. A computer readable medium containing computer executable instructions which, when executed on a controller of a vehicle cruise control system, cause said controller to:
based on at least one user input, obtain an upper speed limit and a lower speed limit for said vehicle;
determine a constant output torque for said rotary engine for said vehicle;
obtain a current speed of said vehicle;
while said current speed lies between said upper speed limit and said lower speed limit, generate an engine control signal to operate said rotary engine at said constant output torque;
if said current vehicle speed increases above said upper speed limit, generate an engine control signal to operate said rotary engine at a reduced output torque below said constant output torque;
if said current vehicle speed decreases below said lower speed limit, generate an engine control signal to operate said rotary engine at an increased output torque above said constant output torque.

8. A cruise control for a land vehicle comprising:
a torque sensor;
a controller receiving an input signal from said torque sensor, a speed sensor, an accelerator pedal, and a user interface, said controller for:
based on at least one user input, obtaining an upper speed limit and a lower speed limit for said vehicle;
determining a constant output torque for said rotary engine for said vehicle;
obtaining a current speed of said vehicle;
while said current speed lies between said upper speed limit and said lower speed limit, generating an engine control signal to operate said rotary engine at said constant output torque;
if said current vehicle speed increases above said upper speed limit, generating an engine control signal to operate said rotary engine at a reduced output torque below said constant output torque;
if said current vehicle speed decreases below said lower speed limit, generating an engine control signal to operate said rotary engine at an increased output torque above said constant output torque.
